(19) United States
(12) Patent Application Publication
(10) Pub. No.: US 2024/0125379 A1
(43) Pub. Date: Apr. 18, 2024

(54) VEHICLE DRIVE DEVICE

(71) Applicant: TOYOTA JIDOSHA KABUSHIKI KAISHA, Toyota-shi (JP)

(72) Inventor: Hiroaki IKEGAMI, Toyota-shi (JP)

(21) Appl. No.: 18/456,526

(22) Filed: Aug. 28, 2023

(30) Foreign Application Priority Data
Oct. 17, 2022 (JP) 2022-166314

(51) Int. Cl. F16H 57/025; B60K 5/00; B60K 17/04; F02F 7/00; F02F 11/00

(52) U.S. Cl. CPC F16H 57/025; B60K 5/00; B60K 17/04; F02F 7/00; F02F 11/002; F16H 2057/02043

(57) ABSTRACT

A vehicle drive device includes an internal combustion engine, a power transmission device, and a reinforcing member coupled to both the internal combustion engine and the power transmission device. A seal is arranged between a cylinder head and a cam housing that are adjacent to each other in a direction parallel to an axis of a cylinder. A reinforcing member is coupled to the cam housing. A first fastening portion of the cam housing that is fastened to the reinforcing member is arranged at a position away from a contact portion of the cam housing that contacts the seal in the direction parallel to the axis.

### RELATED APPLICATION

The present application claims priority of Japanese Patent Application No. 2022-166314 filed on Oct. 17, 2022, the disclosure of which is hereby incorporated by reference herein in its entirety.

### BACKGROUND

### 1. Field

The following description relates to a vehicle drive device including an internal combustion engine and a power transmission device coupled to the internal combustion engine.

### 2. Description of Related Art

Japanese Laid-Open Patent Publication No. 9-195786 discloses a vehicle drive device including an internal combustion engine, a transmission, and a stiffener. The stiffener is a reinforcing member for reinforcing the coupling between a cylinder block of the internal combustion engine and a case of the transmission.

In the internal combustion engine, external structure components forming an outer shape of the internal combustion engine are arranged in a direction parallel to an axis of a cylinder. The external structure components include, for example, the cylinder block, a cylinder head, and a cam housing. A seal is arranged between every two of the external structure components adjacent to each other in the direction parallel to the axis in order to avoid leakage of oil and gas.

When the vehicle drive device is running, the internal combustion engine and the case of the transmission thermally expand. The thermal expansion amount of the internal combustion engine in the direction parallel to the axis differs from that of the case of the transmission. Accordingly, a load that corresponds to the difference between the thermal expansion amount of the internal combustion engine and that of the case of the transmission is applied to a portion where the internal combustion engine is fastened to the stiffener. When the load is transmitted to a portion where the external structure component, fastened to the stiffener, is in contact with the seal, the degree of adhesion may be reduced between the seal and the external structure component.

### SUMMARY

In one general aspect, a vehicle drive device includes an internal combustion engine including a cylinder, a power transmission device connected to the internal combustion engine, and a reinforcing member coupled to both the internal combustion engine and the power transmission device. The internal combustion engine includes external structure components and a seal. The external structure components are arranged in a direction parallel to an axis of the cylinder. The seal is arranged between every two of the external structure components that are adjacent to each other in the direction parallel to the axis. One of the external structure components that is fastened to the reinforcing member defines a specified external structure component. A fastening portion where the specified external structure component is fastened to the reinforcing member is arranged at a position away from a contact portion where the specified external structure component contacts the seal in the direction parallel to the axis.

Other features and aspects will be apparent from the following detailed description, the drawings, and the claims.

### BRIEF DESCRIPTION OF THE DRAWINGS

FIG. 1 is a side view schematically illustrating a part of a vehicle drive device according to an embodiment.

FIG. 2 is a plan view schematically showing a part of the vehicle drive device of FIG. 1.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

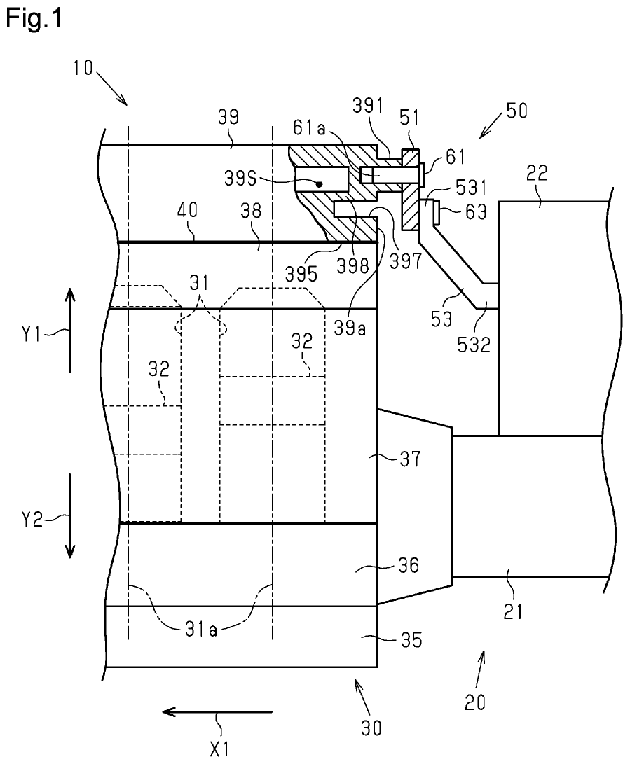

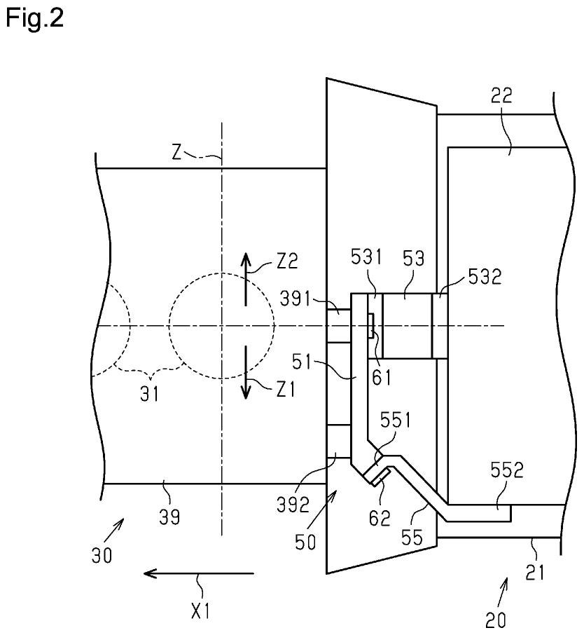

Hereinafter, an embodiment of a vehicle drive device will be described with reference to FIGS. 1 and 2.

As shown in FIG. 1, a vehicle drive device 10 includes an internal combustion engine 30 and a power transmission device 20. Hereinafter, the vehicle drive device 10 will be simply referred to as “the drive device 10”.

Structure of Power Transmission Device

The power transmission device 20 is coupled to the internal combustion engine 30. The power transmission device 20 includes a transmission device 21 and a power control device 22. The transmission device 21 includes a transmission and at least one electric motor. The power control device 22 adjusts the power supplied to the electric motor. The power control device 22 includes a device case and a power supply circuit accommodated in the device case. The transmission device 21 is coupled to the internal combustion engine 30. The power control device 22 is arranged on the transmission device 21.

Structure of Internal Combustion Engine

As shown in FIGS. 1 and 2, the internal combustion engine 30 includes a plurality of cylinders 31. The internal combustion engine 30 is an inline-type internal combustion engine. A direction extending away from the power transmission device 20 that is parallel to a direction in which the cylinders 31 are arranged will be referred to as “the cylinder arrangement direction X1”. Each cylinder 31 accommodates a piston 32 that reciprocates in a direction parallel to an axis 31a of the cylinder 31.

The internal combustion engine 30 includes a plurality of external structure components that form the outer shape of the internal combustion engine 30. The external structure components include an oil pan 35, a crankcase 36, a cylinder block 37, a cylinder head 38, and a cam housing 39. The oil pan 35, the crankcase 36, the cylinder block 37, the cylinder head 38, and the cam housing 39 are arranged in a direction parallel to the axis 31a of the cylinder 31. Specifically, the crankcase 36 is attached to a lower part of the cylinder block 37. The oil pan 35 is attached to a lower part of the crankcase 36. The cylinder head 38 is attached to an upper part of the cylinder block 37. The cam housing 39 is attached to an upper part of the cylinder head 38. A direction parallel to the axis 31a in which the oil pan 35, the crankcase 36, the cylinder block 37, the cylinder head 38, and the cam housing 39 are arranged in this order will be referred to as “the first axial direction Y1”, and the direction opposite to the first axial direction Y1 will be referred to as “the second axial direction Y2”.

A seal is arranged between every two of the external structure components adjacent to each other in the first axial direction Y1 to avoid leakage of oil and gas. For example, a seal 40 is a formed-in-place gasket (FIPG). The seal arranged between the cylinder head 38 and the cam housing 39 will be referred to as “the seal 40”.

An imaginary straight line orthogonal to both the first axial direction Y1 and the cylinder arrangement direction X1 will be referred to as a lateral straight line Z (refer to FIG. 2). One direction extending along the lateral straight line Z will be referred to as a first lateral direction Z1, and the other direction extending along the lateral straight line will be referred to as a second lateral direction Z2. In the present embodiment, the first lateral direction Z1 corresponds to “the specified direction”.

Structure for Reinforcing Connection Between Internal Combustion Engine and Power Transmission Device

The drive device 10 includes a reinforcing member 50 coupled to both the internal combustion engine 30 and the power transmission device 20. The reinforcing member 50 includes a connecting member 51, a first coupling member 53, and a second coupling member 55.

The connecting member 51 is fastened to a specified external structure component, which is one of the external structure components of the internal combustion engine 30. In the present embodiment, the specified external structure component is the cam housing 39. The connecting member 51 is fastened to the cam housing 39 at a central portion in a direction parallel to the lateral straight line Z1. The connecting member 51 is fastened to the cam housing 39 also at a portion separated from the central portion in the first lateral direction Z1. The central portion of the cam housing 39 that is fastened to the connecting member 51 will be referred to as “the first fastening portion 391”. The portion of the cam housing 39 separated from the central portion in the first lateral direction Z1 that is fastened to the connecting member 51 will be referred to as “the second fastening portion 392”.

The first fastening portion 391 is a cylindrical boss projecting toward the power control device 22. In the present embodiment, a bolt 61 fastens the first fastening portion 391 of the cam housing 39 and the connecting member 51. Specifically, a shaft 61a of the bolt 61 is fastened into the first fastening portion 391.

The second fastening portion 392 is a cylindrical boss projecting toward the power control device 22. In the present embodiment, a bolt 62 fastens the second fastening portion 392 of the cam housing 39 and the connecting member 51. Specifically, a shaft of the bolt 62 is fastened into the second fastening portion 392.

As shown in FIG. 1, the first fastening portion 391 and the second fastening portion 392 are arranged away from a contact portion 395 where the cam housing 39 contacts the seal 40 in a direction parallel to the axis 31a of the cylinder 31. Specifically, the first fastening portion 391 and the second coupling member 55 are both separated from the contact portion 395 in the first axial direction Y1.

Further, the cam housing 39 includes a fragile portion between the first fastening portion 391 and the contact portion 395 in a direction parallel to the axis 31a of the cylinder 31. The fragile portion has a lower rigidity than other portions of the cam housing 39 in the direction parallel to the axis 31a. Specifically, the cam housing 39 includes a recess 397 between the first fastening portion 391 and the contact portion 395 in the direction parallel to the axis 31a. The recess 397 forms the fragile portion. The recess 397 is formed in an opposing surface 39a of the cam housing 39 that faces the power control device 22.

In the present embodiment, the cam housing 39 includes an interior cavity 39S in the vicinity of the first fastening portion 391. Accordingly, the recess 397 in the cam housing 39 forms a thin portion 398 between the recess 397 and the interior cavity 39S in the cam housing 39. The thin portion 398 is thinner than other portions. The thin portion 398 is more easily deformed than the other portions. Thus, the thin portion 398 functions as the fragile portion.

A first end 531 of the first coupling member 53 is fastened to the connecting member 51. A second end 532 of the first coupling member 53 is coupled to the case of the power control device 22 of the power transmission device 20. Specifically, the first coupling member 53 is fastened to the power transmission device 20 at a position separated from the first fastening portion 391 in the second axial direction Y2.

The first end 531 of the first coupling member 53 is fastened to the connecting member 51 by the bolt 63. The fastening portion of the first coupling member 53 and the connecting member 51 is located at substantially the same position as the first fastening portion 391 in the direction parallel to the lateral straight line Z.

The second end 532 of the first coupling member 53 is fastened to the case of the power control device 22 by a bolt. Specifically, the second end 532 of the first coupling member 53 is fastened to a central portion of the case of the power control device 22 in the direction parallel to the lateral straight line Z.

The second coupling member 55 is separated from the first coupling member 53 in the first lateral direction Z1. A first end 551 of the second coupling member 55 is fastened to the connecting member 51. A second end 552 of the second coupling member 55 is coupled to the case of the power control device 22 of the power transmission device 20.

The fastening portion of the second coupling member 55 and the connecting member 51 is separated from the fastening portion of the first coupling member 53 and the connecting member 51 in the first lateral direction Z1. The fastening portion of the second coupling member 55 and the power control device 22 is separated from the fastening portion of the first coupling member 53 and the power control device 22 in the first lateral direction Z1.

Operation and Advantages

The reinforcing member 50 couples the power control device 22 and the cam housing 39. This reduces the vibration of the power control device 22. This also reduces the vibration of the internal combustion engine 30.

When the internal combustion engine 30 is running, the internal combustion engine 30 is thermally expanded by fuel combustion inside the cylinders 31 of the internal combustion engine 30. In this case, the thermal expansion amount of the internal combustion engine 30 in the direction parallel to the axis 31a is greater than that of the power transmission device 20 in the direction parallel to the axis 31a. Accordingly, the reinforcing member 50 inputs a load that results from the difference between the thermal expansion amount of the internal combustion engine 30 and that of the power transmission device 20 to the first fastening portion 391 of the cam housing 39 of the internal combustion engine 30.

In the present embodiment, the first fastening portion 391 is separated from the contact portion 395 of the cam housing 39 and the seal 40 in the direction parallel to the axis 31a of the cylinder 31. Thus, even if a load that moves the first fastening portion 391 in the direction parallel to the axis 31a is transmitted to the first fastening portion 391 via the reinforcing member 50, the load is unlikely to be transmitted to the contact portion 395. This is because the load is attenuated between the first fastening portion 391 and the contact portion 395. Therefore, the drive device 10 avoids reduction in the degree of adhesion between the cam housing 39 and the seal 40 caused by the difference between the thermal expansion amount of the internal combustion engine 30 and that of the power transmission device 20.

Further, the thin portion 398 is formed in the cam housing 39 between the first fastening portion 391 and the contact portion 395. The thin portion 398 is a fragile portion having a lower rigidity than that of the other portions of the cam housing 39 in the direction parallel to the axis 31a. The thin portion 398 may be formed by the recess 397 arranged in the cam housing 39. When such a recess 397 is arranged in the cam housing 39, the first fastening portion 391 and the periphery of the first fastening portion 391 are easily deformed by the above-described load transmitted to the first fastening portion 391. For example, the thin portion 398 is deformed. When the first fastening portion 391 and the periphery of the first fastening portion 391 are deformed by the input of the load, the load will not be transmitted to the contact portion 395. This avoids transmission of the load to the contact portion 395 effectively.

The reinforcing member 50 includes the first coupling member 53 and the second coupling member 55. The first coupling member 53 and the second coupling member 55 are separated from each other in the direction parallel to the lateral straight line Z. That is, the second fastening portion 392 is separated from the first fastening portion 391 in the first lateral Z1. This avoids an occurrence of deformation in which the power transmission device 20 is twisted relative to the internal combustion engine 30.

### Modified Examples

The above embodiment may be modified as follows. The above embodiment and the following modifications can be combined as long as the combined modifications remain technically consistent with each other.

The second coupling member 55 may be omitted as long as the first coupling member 53 couples the power transmission device 20 and the internal combustion engine 30. In this case, the connecting member 51 may be omitted, and the first fastening portion 391 may be directly coupled to a component of the internal combustion engine 30.

The fragile portion does not have to be provided in the cam housing 39 as long as the first fastening portion 391 and the contact portion 395 are sufficiently apart from each other.

The sealing may be a liquid gasket other than FIPG. Examples of the liquid gasket other than FIPG include a cured-in-place gasket (CIPG) and the like.

In the above-described embodiment, the reinforcing member is fastened to the cam housing 39. However, the reinforcing member may be fastened to an external structure component other than the cam housing 39. For example, the reinforcing member may be fastened to the cylinder head 38.

It should be noted that the expression “at least one” as used herein means “one or more” of the desired options. As an example, the expression “at least one” as used herein means “only one option” or “both two options” if the number of options is two. As another example, the expression “at least one” used herein means “only one option” or “a combination of any two or more options” if the number of options is three or more.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A vehicle drive device, comprising:
an internal combustion engine including a cylinder;
a power transmission device connected to the internal combustion engine; and
a reinforcing member coupled to both the internal combustion engine and the power transmission device, wherein:
the internal combustion engine includes
external structure components arranged in a direction parallel to an axis of the cylinder, and
a seal arranged between every two of the external structure components that are adjacent to each other in the direction parallel to the axis;
one of the external structure components that is fastened to the reinforcing member defines a specified external structure component; and
a fastening portion where the specified external structure component is fastened to the reinforcing member is arranged at a position away from a contact portion where the specified external structure component contacts the seal in the direction parallel to the axis.

2. The vehicle drive device according to claim 1, wherein the specified external structure component includes a fragile portion between the fastening portion and the contact portion in the direction parallel to the axis, the fragile portion having a rigidity in the direction parallel to the axis that is lower than that of another portion of the specified external structure component.

3. The vehicle drive device according to claim 1, wherein the specified external structure component includes a recess between the fastening portion and the contact portion in the direction parallel to the axis.

4. The vehicle drive device according to claim 1, wherein:
the reinforcing member includes
a first coupling member and a second coupling member that are coupled to the power transmission device, and
a connecting member connected to the specified external structure component;
the cylinder is one of cylinders, the cylinders being arranged in a cylinder arrangement direction;
a direction orthogonal to both the direction parallel to the axis and the cylinder arrangement direction defines a specified direction;
the fastening portion of the specified external structure component defines a first fastening portion;
the first coupling member is coupled to the connecting member;
the second coupling member is fastened to the power transmission device at a position separated in the specified direction from a portion where the power transmission device is fastened to the first coupling member;
the second coupling member is fastened to the connecting member at a position separated in the specified direction from a portion where the connecting member is coupled to the first coupling member; and
the connecting member is fastened to the specified external structure component also at a position separated from the first fastening portion in the specified direction.
